(19) United States
(12) Patent Application Publication
(10) Pub. No.: US 2006/0192189 A1
(43) Pub. Date: Aug. 31, 2006

(54) Easily mountable fence, due to the method used

(76) Inventor: Vahit Uyanik, Istanbul (TR)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/533,508

(22) PCT Filed: Oct. 30, 2002
(86) PCT No.: PCT/TR02/00067

§ 371 Date: Nov. 18, 2005

(51) Int. Cl. A01G 17/06

(52) U.S. Cl. 256/23

(57) ABSTRACT

The fence, which can easily be set up, in general, comprises of a fence module (1), the slots/recesses (2), through which the connecting element (3) passes and that provides the connection and the fixing nut (4); and in the end all these are being combined together to form the fence.

This innovation, is related to a fence, which is gathered together by using connection element, which provides a practical erection (setting up), which does not require an extra maintenance cost, due to its production method and which can be used for the purpose of garden and building surrounding wall, both by itself alone or together with concrete and stone wall, etc.

Human beings are using various border defining methods since many years for the purpose of defining the borders of the buildings, lands and real estates that belong to themselves. They have used wooden and metal fences, barbed wire, concrete and stonewalls to determine the borders of the land that belong to themselves. However, along with the being short of the lifetime of the wooden fences, the being difficult of the construction of the concrete fences, the wearing of the metal wire fence in the course of time and the causing of it to unwanted injuries, have pushed the human beings to work on other products that are more durable, easier to set up and cost less due to reasons like the being impossible of transporting (carrying) of some of these to other places after using these where they have been originally set up and the being inefficient of some of these to use again. Apart from this, the temporary surrounding of a piece of land may be necessary in some cases. The use of concrete, wire and wooden fence for this purpose is far from being preferable. On the other hand, the metal fences, are being produced in the form of a single piece, like a mould, and due to this reason, these cause serious cost and loss of time, in case of even a small shift in the dimensions. In the light of all these, an era of effort to increase the quality of the products used, to increase its durability, the making more practical of these to use and lowering of the costs as much as possible has also been entered in this sector, like in all sectors.

The purpose of this innovation, is being able to realize a fence that is produced by plastics injection method and that can easily be set up due to (thanks to) the connecting method used, since each one part is formed by their being able to be combined/assembled together (to each other) on the spot and hence that can be adjusted to the required dimension in accordance with the area where it will be used.

The fence modules, which may easily be assembled and that has been realized to attain these purposes, have been shown in the following figures. These figures are:

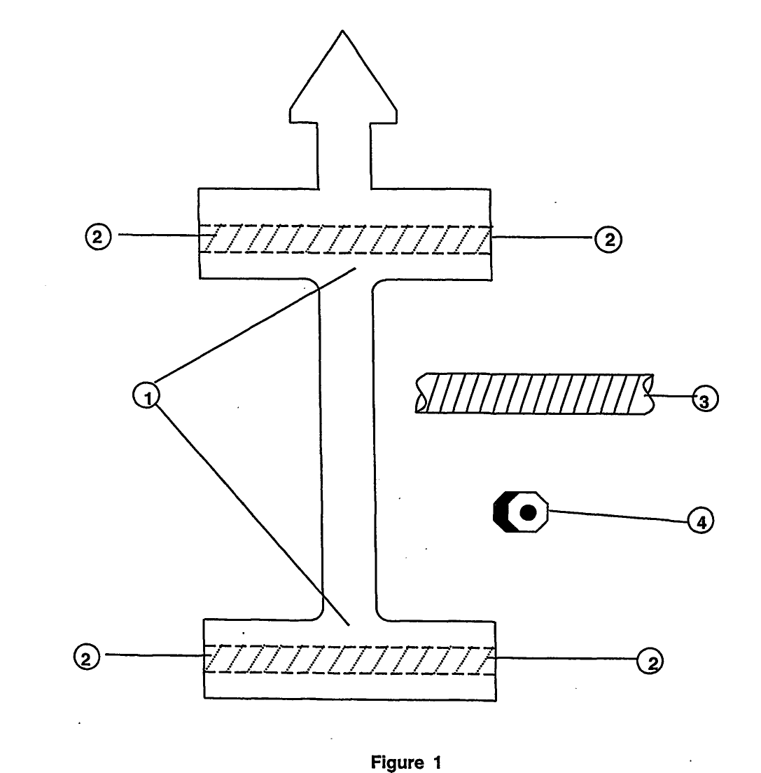

FIG. 1: The front view of a single fence module,

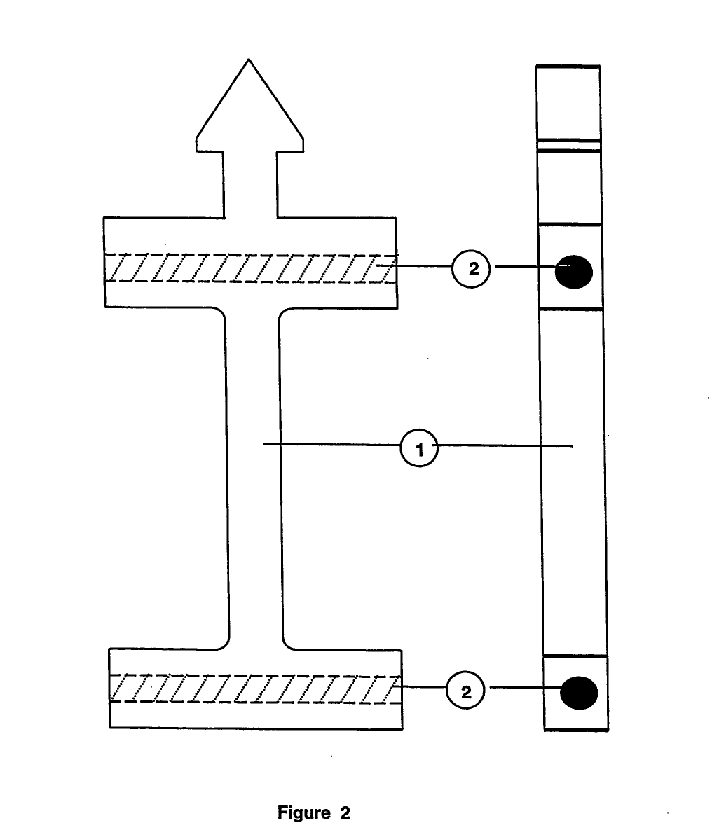

FIG. 2: The side view of a single fence module,

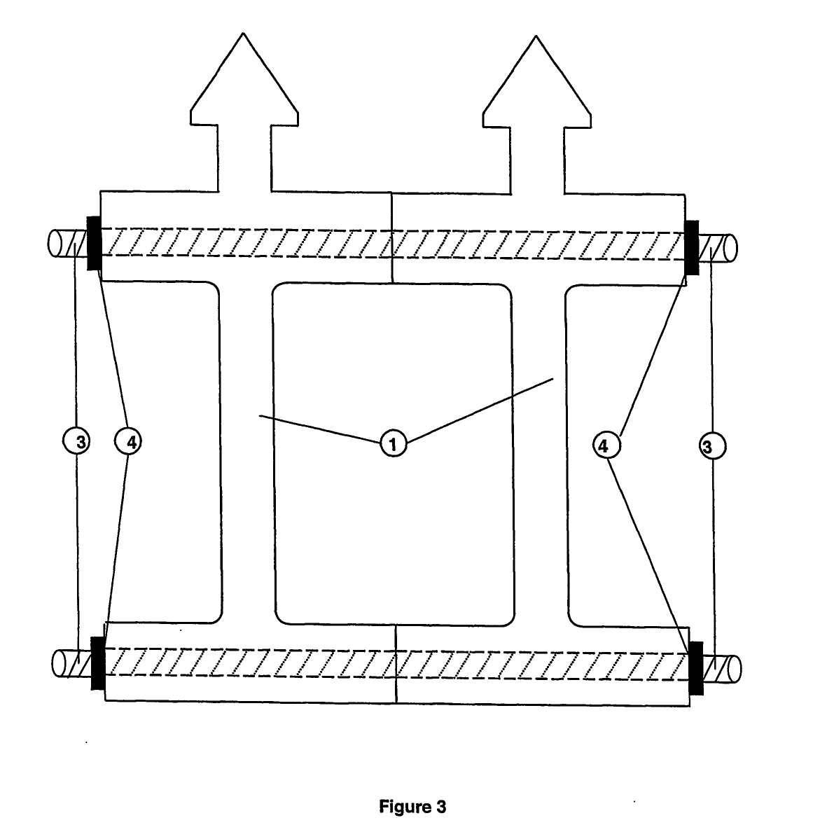

FIG. 3: The combined view of the fence modules.

The parts and the sections in the figures have been numbered one by one and the corresponding counterparts of these numbers have been given herein is below.
(1) —fence module,
(2) —slot,
(3) —connecting element,
(4) —fixing nut.

The fence module (1) that can easily be set up, in general, comprises of the fence module (1), which is produced from colored plastics raw material by plastics injection method and that has slots/recesses (2), both in the upper and in the lower parts of it, the connecting element (3) that realizes the connecting process bay passing it through these slots/recesses (2) and a fixing nut (4).

The fence modules (1), which are made from plastics raw material and that has slots/recesses (2), with sufficient widths, in which the connecting elements (3) at the bottom or at the top or both bottom and also on the top, depending on the need may fit, are being brought together and the connecting element(s) (3), is (are) being passed through these slots/recesses and these are fixed by the fixing nuts (4) from both sides and hence the required no. of fence modules are being added up together to each other and the fence is being completed.

1. A fence, fashioned from raw plastics material by plastics injection moulding technique comprising a fence modules (1), the fence module (1) including a slot/recess (2); a connecting element (3); and a fixing nut (4).

2. The fence as claimed in claim 1 wherein a plurality of the fence modules (1) are connected by fitting the connecting element (3), through the slots/recesses (>that take place on the fence modules (1) and fixing the connecting element with the fixing nut (4).

3. The fence as claimed in claim 1 wherein the slots/recesses (2) are positioned on the top or at the bottom or both at the top and at the bottom of each one of the fence modules (1) that form the fence.

4. The fence as claimed in claim 1 wherein the connecting element includes groove(s).

5. The fence as claimed in claim 1 wherein the nut (4). having toothed of the connecting element (3) and being configured to pass through the connecting element (3).

6. The fence as claimed in claim 1 wherein the fence is adjustable in length in the area where it is being set up.

7. The fence as claimed in claim 1 wherein the raw plastics material is light in weight, and having a fixed color such that extra maintenance is not required.
